(19) United States
(12) Patent Application Publication
(10) Pub. No.: US 2012/0328208 A1
(43) Pub. Date: Dec. 27, 2012

(54) INFORMATION PROCESSING APPARATUS, INFORMATION PROCESSING METHOD, PROGRAM, AND RECORDING MEDIUM

(75) Inventors: Jun LUO, Tokyo (JP); Takefumi NAGUMO, Kanagawa (JP)

(73) Assignee: Sony Corporation, Tokyo (JP)

(21) Appl. No.: 13/523,538

(22) Filed: Jun. 14, 2012

(30) Foreign Application Priority Data
Jun. 21, 2011 (JP) 2011-137681

(51) Int. Cl. G06K 9/36

(52) U.S. Cl. 382/238

(57) ABSTRACT

Provided is an information processing apparatus including a low-bit basic image generating part for generating a low-bit basic image having a low bit depth, a low-bit reference image generating part for generating a low-bit reference image having a low bit depth, a feature value calculating part for calculating a feature value indicating a non-flatness of brightness information of the basic image, a cost value calculating part for calculating a cost value at each of reference block positions in a block matching between the low-bit basic image and the low-bit reference image using the feature value and an estimated motion vector, and a block matching part for calculating a motion vector at each of the reference block positions based on an evaluation value obtained by the block matching between the low-bit basic image and the low-bit reference image after correcting the evaluation value using the calculated cost value.

### BACKGROUND

The present disclosure relates to an information processing apparatus, an information processing method, a program, and a recording medium. Particularly, the present disclosure is for easily and accurately calculating a motion vector.

Based on a motion vector obtained by detecting motion vectors of an object in the images of the different times, for example, an inter-frame coding for the motion-compensated frames during a highly efficient encoding of an image, or a noise reduction by an inter-frame filtering in the time domain has been performed in the past.

For example, a block matching as described in Japanese Patent Application Laid-Open No. 2007-136184 is used as a method for obtaining the motion vector. In such a block matching, one screen is divided into blocks composed of some pixels. Then an evaluation value is calculated using a predetermined evaluation function. The evaluation value indicates the similarity between the blocked image and an image in a region to be examined set in another screen at the different time. The different time screen is for detecting the region in which the image has moved. Then, the motion vector is detected based on the calculated evaluation value.

In such a block matching, the similarity between a block of which motion vector is to be detected and each of the blocks in the region to be examined is preferably found at each of the block positions. This increases the amount of calculation for detecting the motion vector. Thus, a motion vector is detected using a low-bit image having a low bit depth obtained by reducing the number of bits in each of the pixels in U.S. Pat. No. 5,793,985.

### SUMMARY

There is a risk that the accuracy of detecting the motion vector is reduced because the reduced number of bits reduces the image information when the motion vector is detected using the low-bit image. Particularly, the difference between the evaluation values such as a Sum of Absolute Difference (SAD) in the flat part of the image decreases when the reduced number of bits reduces the image information. Thus, it is difficult to stably detect an accurate motion vector. This causes, for example, the dispersion of the motion vectors.

In view of the foregoing, it is desirable in the present disclosure to provide an information processing apparatus, an information processing method, a program, and a recording medium capable of more accurately detecting a motion vector by a simple configuration.

According to an embodiment of the present disclosure, there is provided an information processing apparatus which includes a low-bit basic image generating part for generating a low-bit basic image having a low bit depth from a basic image, a low-bit reference image generating part for generating a low-bit reference image having a low bit depth from a reference image, a feature value calculating part for calculating a feature value indicating a non-flatness of brightness information of the basic image, a cost value calculating part for calculating a cost value at each of reference block positions in a block matching between the low-bit basic image and the low-bit reference image using the feature value of a block in the basic image corresponding to a block in the low-bit basic image and an estimated motion vector set at the block in the low-bit basic image, and a block matching part for calculating a motion vector at each of the reference block positions based on an evaluation value after correcting the evaluation value using the calculated cost value, the evaluation value being obtained by the block matching between the low-bit basic image and the low-bit reference image.

In the present disclosure, for example, the number of bits of an m-bit basic image is reduced to generate a low-bit basic image which is n bit(s) and has a bit depth lower than that of the m bits. The number of bits of a reference image is similarly reduced to generate a low-bit reference image. Then a feature value indicating the non-flatness of the brightness information is calculated at each of the blocks using the basic image. For example, using a basic image filtered according to a mean filter or a band-pass filter, a dynamic range or a deviation of the brightness information is calculated as the feature value at each of the blocks. A cost value at each of the block positions in a block matching between the low-bit basic image and the low-bit reference image is calculated using the feature value and estimated motion vectors. A difference function is used for calculating the cost value. The difference function indicates the difference between the motion vector and the estimated vector. The motion vector denotes the motion of the block between the low-bit basic image and the low-bit reference image in the block matching. Further, the upper limit of the difference is limited to a predetermined value. For example, motion vectors of the blocks adjacent to a current block of which motion vector is to be calculated in the basic image, motion vectors of the blocks adjacent to the current block in the basic image where the motion vector of each of the blocks has been provisionally calculated, motion vectors calculated by gathering statistics of the motion vectors of the adjacent blocks, and a zero vector are used as the estimated motion vector. Furthermore, an evaluation value is corrected using the cost value calculated at each of the block positions. The evaluation value has been obtained by a block matching between the low-bit basic image and the low-bit reference image. The evaluation value is denoted as a Sum of Absolute Difference. The motion vector is calculated based on a reference block position having the minimum corrected evaluation value and corresponding to that of the current block.

According to another embodiment of the present disclosure, there is provided an information processing method which includes generating a low-bit basic image having a low bit depth from a basic image; a low-bit reference image generating part for generating a low-bit reference image having a low bit depth from a reference image; calculating a feature value indicating a non-flatness of brightness information of the basic image; calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and calculating a motion vector at each of the reference block positions based on an evaluation value after correcting the evaluation value using the calculated cost value, the evaluation value being obtained by the block matching between the low-bit basic image and the low-bit reference image.

According to another embodiment of the present disclosure, there is provided a program for calculating a motion vector on a computer, and the program is for, on the computer, generating a low-bit basic image having a low bit depth from a basic image; generating part for generating a low-bit reference image having a low bit depth from a reference image; calculating a feature value indicating a non-flatness of brightness information of the basic image; calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and calculating a motion vector at each of the reference block positions based on an evaluation value after correcting the evaluation value using the calculated cost value, the evaluation value being obtained by the block matching between the low-bit basic image and the low-bit reference image.

According to another embodiment of the present disclosure, there is provided a computer-readable recording medium storing a program for calculating a motion vector on a computer, and the computer-readable recording medium recording the program is for, on the computer, generating a low-bit basic image having a low bit depth from a basic image; generating part for generating a low-bit reference image having a low bit depth from a reference image; calculating a feature value indicating a non-flatness of brightness information of the basic image; calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and calculating a motion vector at each of the reference block positions based on an evaluation value after correcting the evaluation value using the calculated cost value, the evaluation value being obtained by the block matching between the low-bit basic image and the low-bit reference image.

Note that the program according to the present discloser can be provided to a computer through a computer-readable storage medium such as an optical disk, a magnetic disk, or a semiconductor memory. For example, the computer is a general computer that can execute various program codes. Such a program is provided in a computer-readable format so that a process according to the program is implemented on the computer.

According to the present disclosure, a feature value indicating the non-flatness of the brightness information is calculated at each of the blocks in the basic image. Using the feature value and estimated motion vectors, the cost value at each of the reference block positions is calculated in the block matching between a low-bit basic image and a low-bit reference image. An evaluation value is corrected to calculate a motion vector at each of the reference blocks based on the corrected evaluation value. The evaluation value is obtained by the block matching between a low-bit basic image and a low-bit reference image using the calculated cost value. As described above, in view of not only the evaluation value obtained by the block matching but also the non-flatness of the brightness information, the estimated motion vectors of the adjacent blocks, or the like, the motion vector is calculated. Accordingly, the motion vector can be more accurately calculated by a simple configuration than the motion vector calculated by a block matching between a basic image and a reference image of which the number of bits has not been reduced, or than the motion vector calculated based only on the evaluation value obtained by the block matching.

### BRIEF DESCRIPTION OF THE DRAWINGS

FIG. 1 is a view of the configuration of an information processing apparatus;

FIG. 2 is a flowchart of the operation of the information processing apparatus;

FIG. 3 is a view of the configuration of a low-bit basic image generating part to generate a one-bit image;

FIG. 4 is a flowchart of the operation of the low-bit basic image generating part to generate a one-bit image;

FIG. 5 is a view of the configuration of the low-bit basic image generating part to generate a two-bit image;

FIG. 6 is a flowchart of the operation of the low-bit basic image generating part to generate a two-bit image;

FIG. 7 is a view of the configuration of the low-bit basic image generating part to generate an n-bit image;

FIG. 8 is a flowchart of the operation of the low-bit basic image generating part to generate an n-bit image;

FIG. 9 is an exemplary view of the relationship between a comparison result and a pixel value;

FIG. 10 is a flowchart of the operation of a feature value calculation;

FIG. 11 is an exemplary view of the calculated motion vectors of adjacent blocks;

FIG. 12 is a view of the configuration of a block matching part;

FIG. 13 is a flowchart of the operation of the block matching part;

FIG. 14 is an explanatory view of the process of an XOR value calculation; and

FIG. 15 is a view of an exemplary configuration of hardware on a computer.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Embodiments of the present disclosure will be described hereinafter. The information processing apparatus according to the present disclosure reduces the number of bits of a basic image and a reference image to generate a low-bit basic image and a low-bit reference image that have a low bit depth. The bits are allocated to a pixel. Next, the information processing apparatus calculates the feature value from the basic image to calculate the cost value at each of the reference block positions for a block matching using the calculated feature value and estimated motion vectors. The cost value is used for correcting the evaluation value obtained by the block matching to calculate the motion vector based on the corrected evaluation value. Note that the description will be given in the following order.

1. Configuration of Information Processing Apparatus

2. Operation of Information Processing Apparatus

3. Configuration and Operation of Low-bit Image Generating Part

4. Operation of Feature Value Calculating Part

5. Operation of Cost Value Calculating Part

6. Configuration and Operation of Block Matching Part

7. Process Performed by Program

### <1. Configuration of Information Processing Apparatus>

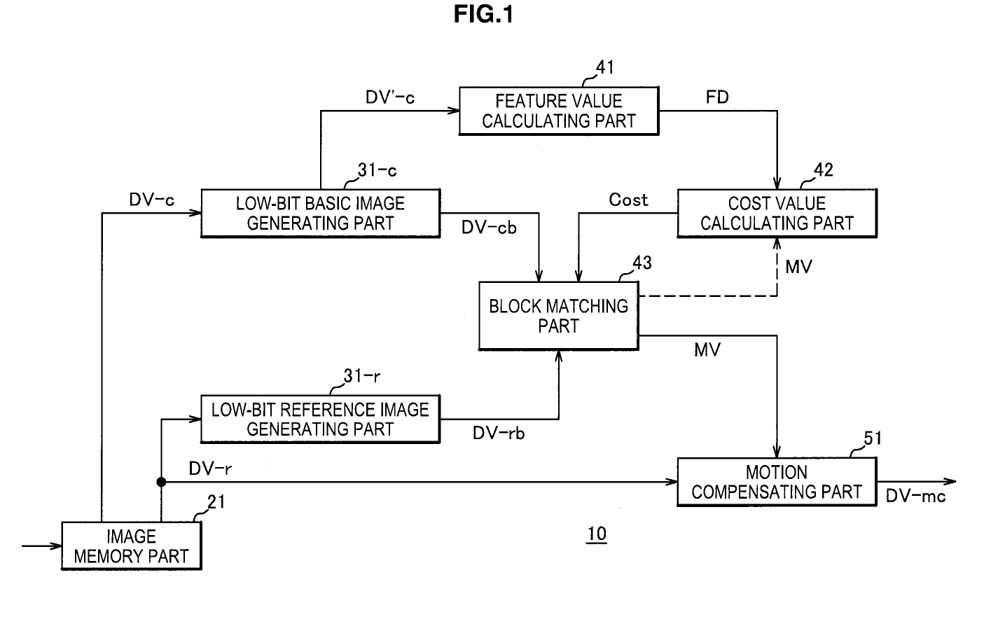

FIG. 1 is a view of the configuration of an information processing apparatus. An information processing apparatus 10 includes an image memory part 21 that stores input image data. The information processing apparatus 10 further includes a low-bit basic image generating part 31-c and a low-bit reference image generating part 31-r that reduce the number of bits allocated to a pixel. The information processing apparatus 10 further includes a feature value calculating part 41, a cost value calculating part 42, and a block matching part 43. Note that the information processing apparatus 10 is provided with a motion compensating part 51 that performs a motion compensation using a calculated motion vector.

The image memory part 21 stores image data on a basic image and a reference image. The image memory part 21 outputs stored image data DV-c on the basic image to the low-bit basic image generating part 31-c. The image memory part 21 outputs stored image data DV-r on the reference image to the low-bit reference image generating part 31-r and the motion compensating part 51.

The low-bit basic image generating part 31-c reduces the number of bits of the image data DV-c on the basic image to generate the image data DV-cb on a low-bit basic image having a lower bit depth than that of the basic image. The low-bit basic image generating part 31-c also outputs the generated image data DV-cb on the low-bit basic image to the block matching part 43. For example, the low-bit basic image generating part 31-c reduces the number of bits of eight-bit image data on a basic image to generate one-bit image data DV-cb on the low-bit basic image and output the image data DV-cb to the block matching part 43. The low-bit basic image generating part 31-c also outputs image data DV′-c on the filtered basic image to the feature value calculating part 41. The filtered image data DV′-c have been generated by the bit number reduction.

The low-bit reference image generating part 31-r reduces the number of bits of the image data DV-r on the reference image to generate the image data DV-rb on a low-bit reference image having a lower bit depth than that of the reference image, for example, the same bit depth as that of the low-bit basic image. The low-bit reference image generating part 31-r also outputs the generated image data DV-rb on the low-bit reference image to the block matching part 43. For example, the low-bit reference image generating part 31-r reduces the number of bits of eight-bit image data on a reference image to generate one-bit image data DV-rb on the low-bit reference image and outputs the image data DV-rb to the block matching part 43.

The feature value calculating part 41 calculates, at each of the blocks in the low-bit basic image, a feature value FD according to the non-flatness of the brightness using the brightness information in the region of the basic image relative to the block and then outputs the feature value FD to the cost value calculating part 42. The cost value calculating part 42 calculates, at each of the reference block positions in a block matching, the cost value Cost using the difference function and the feature value FD. The difference function indicates the difference between the motion vector and the estimated motion vector. The motion vector denotes the motion between a block of the low-bit basic image (current block) and a reference block of the region to be examined in the reference image (hereinafter, referred to as “examination position motion vector”). The cost value calculating part 42 also outputs the cost value Cost calculated at each of the reference block positions to the block matching part 43.

The block matching part 43 performs a block matching using the image data DV-cb on the low-bit basic image output from the low-bit basic image generating part 31-c and the image data DV-rb on the low-bit reference image output from the low-bit reference image generating part 31-r. The block matching part 43 also corrects, at each of the reference block positions, the evaluation value using the cost value, and then calculates a motion vector MV from the block position having the minimum corrected evaluation value. The evaluation value has been obtained by the block matching. The block matching part 43 then outputs the calculated motion vector MV to the motion compensating part 51.

The motion compensating part 51 compensates the motion in the reference image based on the motion vector MV calculated in the block matching part 43 in the same manner as an information processing apparatus in the past, and then outputs image data DV-mc on the motion-compensated image.

### <2. Operation of Information Processing Apparatus>

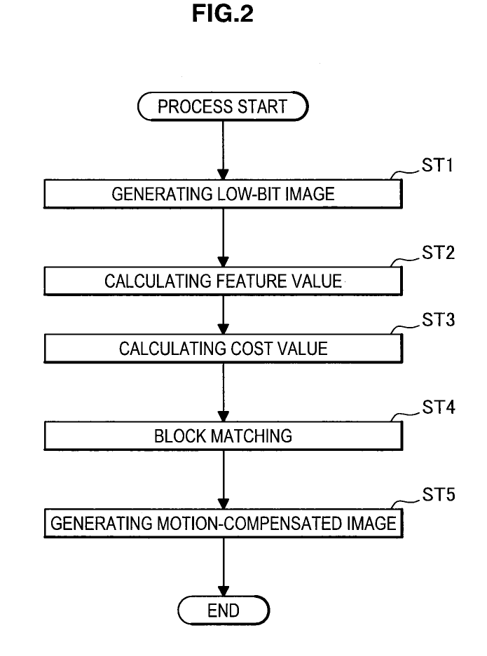

FIG. 2 is a flowchart of the operation of the information processing apparatus. The low-bit basic image generating part 31-c and the low-bit reference image generating part 31-r generate a low-bit image in step ST1. The low-bit basic image generating part 31-c reduces the number of bits of the image data DV-c on the basic image to generate the image data DV-cb on the low-bit basic image. The low-bit reference image generating part 31-r reduces the number of bits of the image data DV-r on the reference image to generate the image data DV-rb on the low-bit reference image. As described above, the low-bit basic image generating part 31-c and the low-bit reference image generating part 31-r generate a low-bit image and then the process goes to step ST2.

The feature value calculating part 41 calculates a feature value in step ST2. The feature value calculating part 41 calculates, at each of the blocks in the low-bit basic image, the feature value according to the brightness information and then the process goes to step ST3.

The cost value calculating part 42 calculates a cost value in step ST3. The cost value calculating part 42 calculates, at each of the reference block positions in a block matching, the cost value using the difference function and the calculated feature value. The difference function indicates the difference between the examination position motion vector and the estimated motion vector. The examination position motion vector denotes the motion between a block of the low-bit basic image and the reference block. The process then goes to step ST4.

The block matching part 43 performs a block matching in step ST4. The block matching part 43 performs a block matching using the image data DV-cb on the low-bit basic image and the image data DV-rb on the low-bit reference image in units of blocks and calculates the evaluation value at each of the reference block positions. The block matching part 43 further corrects the evaluation value at each of the reference block positions using the calculated cost value. The block matching part 43 further finds the motion vector MV between the current block of the basic image and the reference block position of the reference image and then the process goes to step ST5. The corrected evaluation value between the current block and the reference block position is minimum.

The motion compensating part 51 generates a motion-compensated image in step ST5. The motion compensating part 51 compensates the motion in the reference image according to the motion vector MV calculated in step ST4 and generates the image data DV-mc on the motion-compensated image. The process is then terminated.

### <3. Configuration and Operation of Low-Bit Image Generating Part>

Next, the generation of a low-bit image will be described. The low-bit basic image generating part 31-c filters the basic image and compares the image data before filtering to those after filtering at each of the pixels to generate the image data DV-cb on the low-bit basic image according to the comparison result. Similarly, the low-bit reference image generating part 31-r filters the reference image and compares the image data before filtering to those after filtering at each of the pixels to generate the image data DV-rb on the low-bit reference image according to the comparison result.

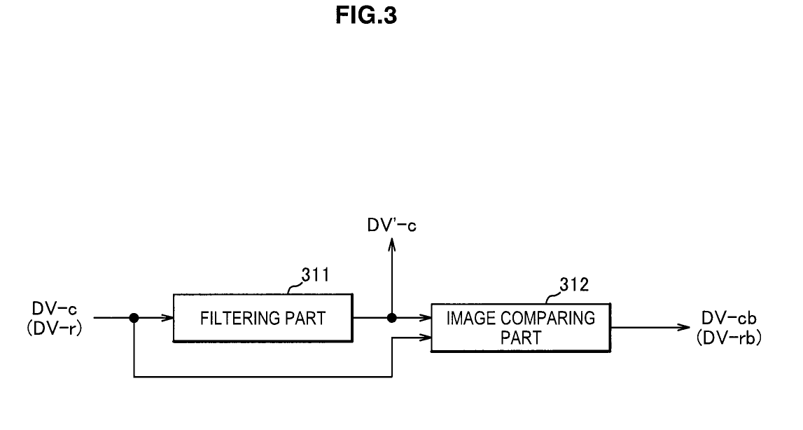

FIG. 3 is a view of the configuration of the low-bit basic image generating part 31-c to generate a one-bit image. Note that the low-bit reference image generating part 31-r is included as well as the low-bit basic image generating part 31-c to process the reference image in the same manner as the low-bit basic image generating part 31-c.

The low-bit basic image generating part 31-c includes a filtering part 311 and an image comparing part 312. The filtering part 311 filters the image data DV-c on the basic image. The filtering part 311 filters the image data DV-c on the basic image using, for example, a mean filter, a band-pass filter, or a pseudo mean filter.

When using the mean filter, the filtering part 311 calculates pixel data I′ (x, y) by solving an expression (1). The pixel data I′ (x, y) is the filtered data of the pixel position (x, y). Note that I (i, j) denotes the pixel data of the basic image and N denotes the number of pixels.

$${I}^{′} ( x , y ) = \frac{1}{{N}^{2}} {\sum }_{i = x - \frac{N}{2}}^{x + \frac{N}{2}} {\sum }_{j = y - \frac{N}{2}}^{y + \frac{N}{2}} I ( i , j ) \qquad ( 1 )$$

When using the band-pass filter, the filtering part 311 calculates pixel data I′ (x, y) by solving an expression (2). The pixel data I′ (x, y) is the filtered data of the pixel position (x, y). Note that “K” in the expression (2) denotes a coefficient for determining the filter property and includes, for example, the value shown in an expression (3).

$$\begin{matrix} {I}^{′} ( x , y ) = {\sum }_{i = x - \frac{N}{2}}^{x + \frac{N}{2}} {\sum }_{j = y - \frac{N}{2}}^{y + \frac{N}{2}} ( I ( i , j ) \times K ( i + \frac{N}{2} , j + \frac{N}{2} ) ) & ( 2 ) \\ K = \frac{1}{16} [ \begin{matrix}0 & 0 & 0 & 0 & 0 & 0 & 0 & 0 & 0 & 1 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 1 & 0 & 0 & 0 & 0 & 0 & 1 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 1 & 0 & 0 & 0 & 0 & 0 & 1 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 1 & 0 & 0 & 0 & 0 & 0 & 1 & 0 & 0 & 0 & 0 & 0 & 1 & 0 & 0 & 0 & 0 & 0 & 1 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 1 & 0 & 0 & 0 & 0 & 0 & 1 & 0 & 0 & 0 & 0 & 0 & 1 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 1 & 0 & 0 & 0 & 0 & 0 & 1 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 0 & 0 & 0 & 0 & 0 & 0 & 0 & 0 & 0 & 0 \\ 0 & 0 & 0 & 0 & 0 & 0 & 0 & 0 & 0 & 1 & 0 & 0 & 0 & 0 & 0 & 0 & 0 & 0 & 0\end{matrix} ] & ( 3 )\end{matrix}$$

When using the pseudo mean filter, the filtering part 311 calculates pixel data I′ (x, y) by solving an expression (4). The pixel data I′ (x, y) is the filtered data of the pixel position (x, y).

$${I}^{′} ( x , y ) = \frac{1}{2} ( {max}_{( i , j ) ∈ ( N \times N )} ( I ( i , j ) ) + {min}_{( i , j ) ∈ ( N \times N )} ( I ( i , j ) ) ) \qquad ( 4 )$$

The image comparing part 312 compares the image data to the filtered image data on the basic image and assumes the one-bit signal indicating the comparison result as the image data on the low-bit basic image.

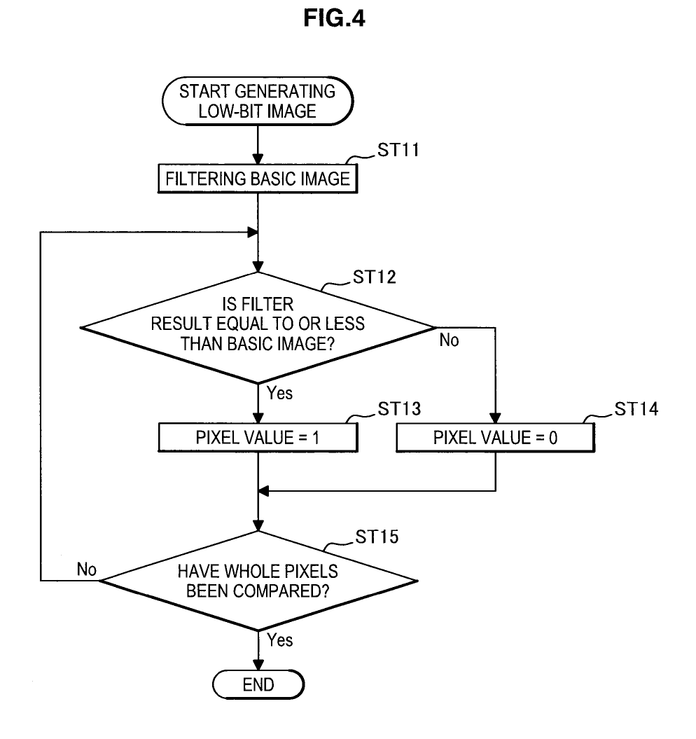

FIG. 4 is a flowchart of the operation of the low-bit basic image generating part 31-c to generate a one-bit image. The low-bit basic image generating part 31-c filters the basic image in step ST11. The low-bit basic image generating part 31-c filters the image data DV-c on the basic image according to the mean filter, the band-pass filter, or the like and then the process goes to step ST12.

The low-bit basic image generating part 31-c determines in step ST12 whether the filter result is equal to or less than the image data on the basic image. The low-bit basic image generating part 31-c compares, at each of the positions in the image, the pixel data in the filtered image data on the image to those in the image data on the basic image. The low-bit basic image generating part 31-c operates the process in step ST13 when the pixel data on the filter result is equal to or less than those on the basic image. Alternatively, the low-bit basic image generating part 31-c operates the process in step ST14 when the pixel data on the filter result is larger than those on the basic image. The low-bit basic image generating part 31-c sets the pixel value as “1” in step ST13 and then the process goes to step ST15.

The low-bit basic image generating part 31-c sets the pixel value as “0” in step ST14 and then the process goes to step ST15.

The low-bit basic image generating part 31-c determines in step ST15 whether all the pixels have been compared. The low-bit basic image generating part 31-c operates the process in step ST12 to compare the next pixel when not all the pixels have been compared. Alternatively, the low-bit basic image generating part 31-c terminates the process when all the pixels have been compared.

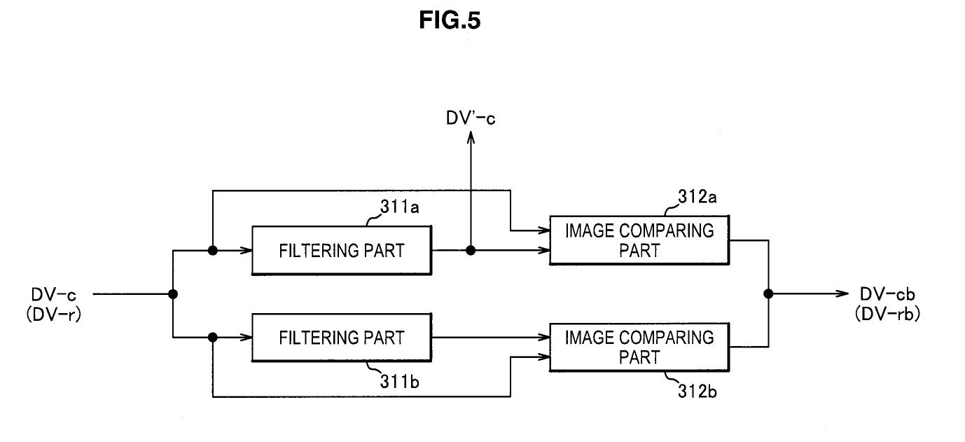

As described above, the image data before filtering are compared to those after filtering at each of the pixels so that the image data DV-cb on the basic image can be generated. The number of bits to be allocated to the pixel has been determined as one bit in the image data DV-cb according to the comparison result. The low-bit reference image generating part 31-r can also generate the image data DV-rb on the low-bit reference image by operating the same process as the low-bit basic image generating part 31-c. Next, the cases when the low-bit basic image generating part 31-c generates a two-bit image and when the low-bit basic image generating part 31-c generates an n-bit image will be described. FIG. 5 is a view of the configuration of the low-bit basic image generating part 31-c to generate a two-bit image.

The low-bit basic image generating part 31-c includes filtering parts 311a and 311b, and image comparing parts 312a and 312b. The filtering part 311a filters the image data on a basic image. The filtering part 311a filters the image data on the basic image using, for example, the mean filter, the band-pass filter, or the pseudo mean filter as described above. The image comparing part 312a compares the image data to the filtered image data on the basic image and assumes the one-bit signal indicating the comparison result as the least significant bit data on the two-bit image. The filtering part 311b filters the image data on the basic image using a different filter property from that of the filtering part 311a. The filtering part 311b filters the image data on the basic image using, for example, the mean filter, the band-pass filter, or the pseudo mean filter in the same manner as the filtering part 311a. The image comparing part 312b compares the image data to the filtered image data on the basic image and assumes the one-bit signal indicating the comparison result as the most significant bit data on the two-bit image.

As described above, the image data before filtering are compared to those after filtering at each of the pixels so that the image data DV-cb on the basic image can be generated. The number of bits to be allocated to the pixel has been determined as two bits in the image data DV-cb according to the comparison result.

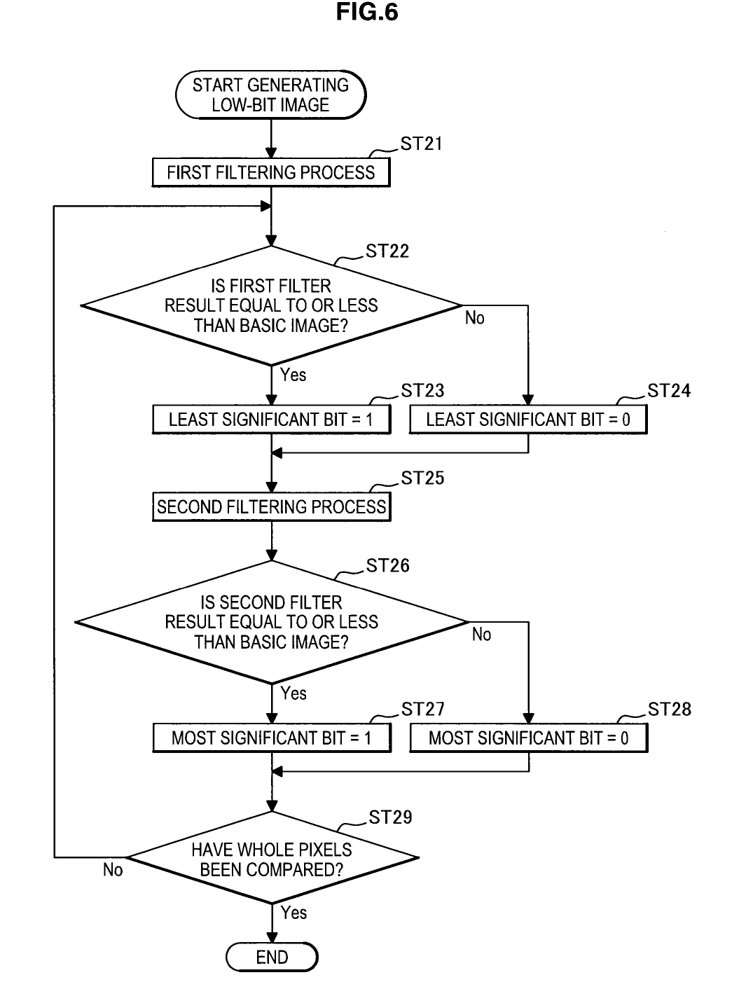

FIG. 6 is a flowchart of the operation of the low-bit basic image generating part 31-c to generate a two-bit image. The low-bit basic image generating part 31-c performs a first filtering process on a basic image in step ST21. The low-bit basic image generating part 31-c performs the first filtering process on the image data on the basic image using, for example, the mean filter or the band-pass filter and then the process goes to step ST22.

The low-bit basic image generating part 31-c determines in step ST22 whether the result of the first filtering process is equal to or less than the image data on the basic image. The low-bit basic image generating part 31-c compares the pixel data at each of the positions in the image using the filtered image data and the image data on the basic image. The low-bit basic image generating part 31-c operates the process in step ST23 when the pixel data on the filter result is equal to or less than those on the basic image. Alternatively, the low-bit basic image generating part 31-c operates the process in step ST24 when the pixel data on the filter result is larger than those on the basic image.

The low-bit basic image generating part 31-c sets the pixel value as “1” and assumes the pixel value as the least significant bit data in the two-bit image in step ST23 and then the process goes to step ST25.

The low-bit basic image generating part 31-c sets the pixel value as “0” and interprets the pixel value as the least significant bit data in the two-bit image in step ST24 and then the process goes to step ST25.

The low-bit basic image generating part 31-c performs a second filtering process on the basic image in step ST25. The low-bit basic image generating part 31-c performs the second filtering process on the image data on the basic image using, for example, the mean filter or the band-pass filter that has a different filter property from that in step ST21 and then the process goes to step ST26.

The low-bit basic image generating part 31-c determines in step ST26 whether the result of the second filtering process is equal to or less than the image data on the basic image. The low-bit basic image generating part 31-c compares the pixel data at each of the positions in the image using the filtered image data and the image data on the basic image. The low-bit basic image generating part 31-c operates the process in step ST27 when the pixel data on the filter result is equal to or less than those on the basic image. Alternatively, the low-bit basic image generating part 31-c operates the process in step ST28 when the pixel data on the filter result is larger than those on the basic image.

The low-bit basic image generating part 31-c sets the pixel value as “1” and assumes the pixel value as the most significant bit data in the two-bit image in step ST27 and then the process goes to step ST29.

The low-bit basic image generating part 31-c sets the pixel value as “0” and assumes the pixel value as the most significant bit data in the two-bit image in step ST28 and then the process goes to step ST29.

The low-bit basic image generating part 31-c determines in step ST29 whether all the pixels have been compared. The low-bit basic image generating part 31-c operates the process in step ST22 to compare the next pixel when not all the pixels have been compared. Alternatively, the low-bit basic image generating part 31-c terminates the process when all the pixels have been compared.

As described above, the image data before filtering are compared to those after filtering at each of the pixels so that the image data DV-cb on the basic image can be generated. The number of bits to be allocated to the pixel has been determined as two bits in the image data DV-cb according to the comparison result. The low-bit reference image generating part 31-r can also generate the image data DV-rb of the low-bit reference image by operating the same process as the low-bit basic image generating part 31-c.

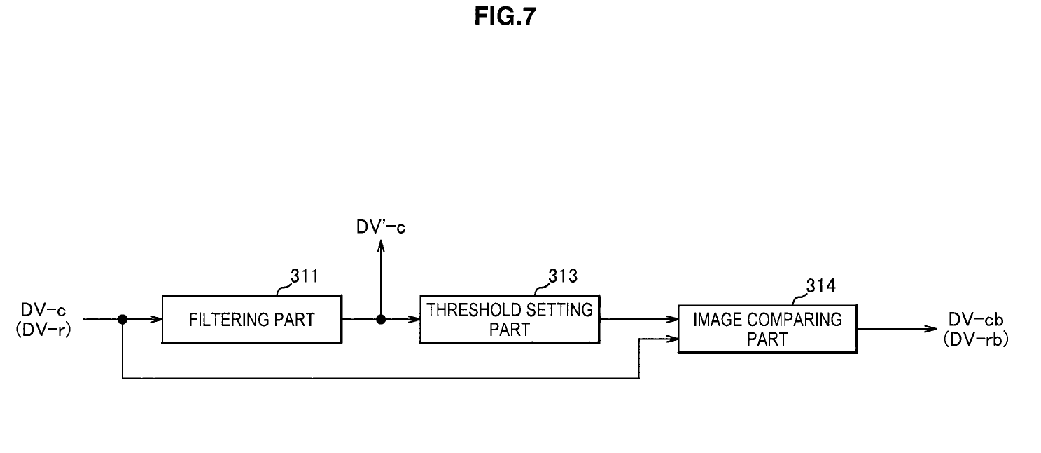

Next, the case when the low-bit basic image generating part 31-c generates an n-bit image will be described. FIG. 7 is a view of the configuration of the low-bit basic image generating part 31-c to generate an n-bit image.

The low-bit basic image generating part 31-c includes the filtering part 311, a threshold setting part 313, and an image comparing part 314. The filtering part 311 filters the image data DV-c on the basic image. The filtering part 311 filters the basic image using, for example, a mean filter, a band-pass filter, or a pseudo mean filter as described above.

The threshold setting part 313 shifts the filtered image data and sets the filtered image data or the shifted image data as a threshold. The threshold setting part 313 then outputs the set threshold to the image comparing part 314.

The image comparing part 314 compares the image data on the basic image to the threshold output from the threshold setting part 313 at each of the pixels and assumes the n-bit signal indicating the comparison result as the image data DV-cb on the low-bit basic image.

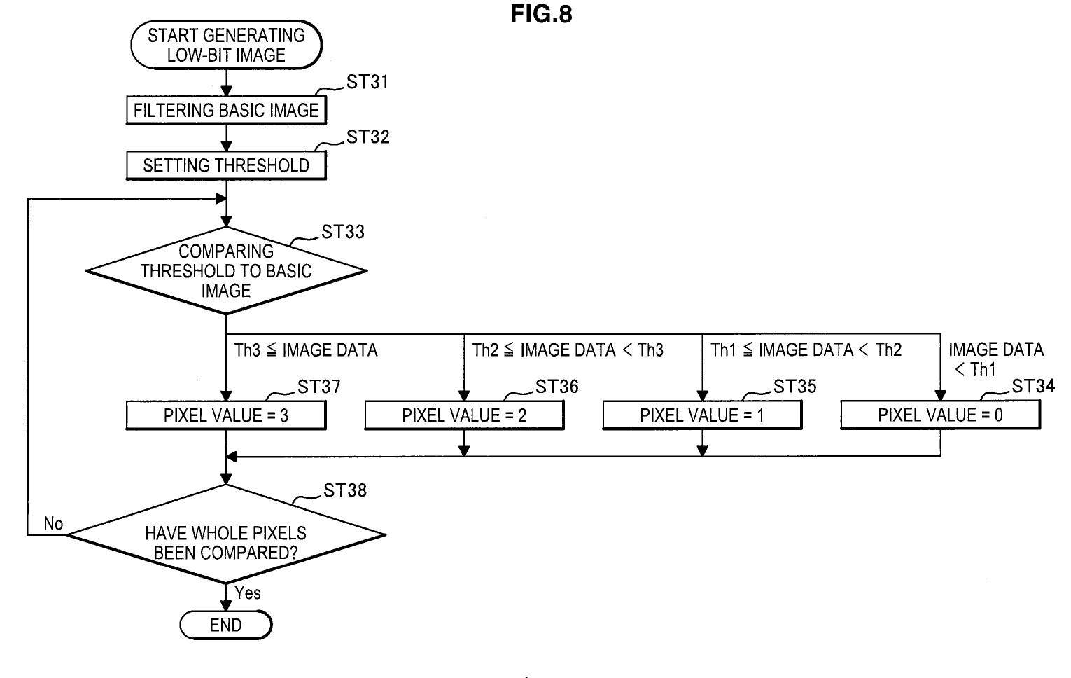

FIG. 8 is a flowchart of the operation of the low-bit basic image generating part 31-c to generate an n-bit image. The low-bit basic image generating part 31-c filters the basic image in step ST31. The low-bit basic image generating part 31-c filters the image data on the basic image according to the mean filter, the band-pass filter, or the like and then the process goes to step ST32.

The low-bit basic image generating part 31-c sets a threshold in step ST32. The low-bit basic image generating part 31-c shifts the filtered image data and sets the filtered image data or the shifted image data as the threshold and then the process goes to step ST33. For example, when generating a two-bit image, the low-bit basic image generating part 31-c sets the image data obtained by reducing the filtered image data by a preset shift amount as a first threshold. The low-bit basic image generating part 31-c further sets the filtered image data as a second threshold, and furthermore sets the image data obtained by increasing the filtered image data by the preset shift amount as a third threshold. Also, when generating an n-bit image, the low-bit basic image generating part 31-c sets (2n−1) thresholds based on the filtered image data.

The low-bit basic image generating part 31-c compares the image data on the basic image to the threshold at each of the pixels in step ST33. The low-bit basic image generating part 31-c performs the process in step ST34 when the image data on the basic image is less than a first threshold Th1. The low-bit basic image generating part 31-c performs the process in step ST35 when the image data on the basic image is equal to or larger than the first threshold Th1 and less than a second threshold Th2. The low-bit basic image generating part 31-c performs the process in step ST36 when the image data on the basic image is equal to or larger than the second threshold Th2 and less than a third threshold Th3. The low-bit basic image generating part 31-c performs the process in step ST37 when the image data on the basic image is equal to or larger than the third threshold Th3.

The low-bit basic image generating part 31-c sets the pixel value as “0” in step ST34 and then the process goes to step ST38.

The low-bit basic image generating part 31-c sets the pixel value as “1” in step ST35 and then the process goes to step ST38.

The low-bit basic image generating part 31-c sets the pixel value as “2” in step ST36 and then the process goes to step ST38.

The low-bit basic image generating part 31-c sets the pixel value as “3” in step ST37 and then the process goes to step ST38.

The low-bit basic image generating part 31-c determines in step ST38 whether all the pixels have been compared. The low-bit basic image generating part 31-c operates the process in step ST32 to compare the next pixel when not all the pixels have been compared. Alternatively, the low-bit basic image generating part 31-c terminates the process when all the pixels have been compared.

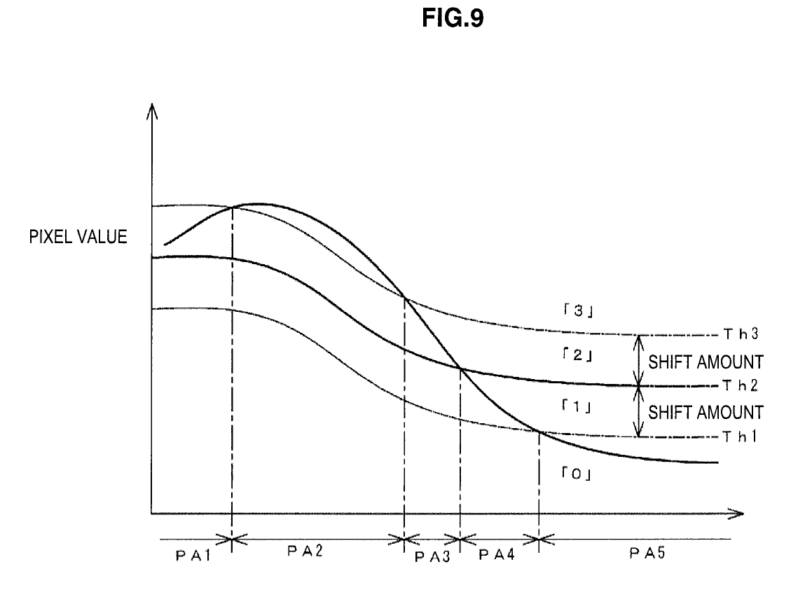

FIG. 9 is an exemplary view of the relationship between a comparison result and a pixel value. When the pixel position is in a region PA1, the pixel value of the basic image is equal to or larger than the second threshold Th2 and less than the third threshold Th3. Accordingly, the low-bit basic image generating part 31-c determines the pixel value of the region PA1 as “2”. When the pixel position is in a region PA2, the pixel value of the basic image is equal to or larger than the third threshold Th3. Accordingly, the low-bit basic image generating part 31-c determines the pixel value of the region PA2 as “3”. When the pixel position is in a region PA3, the pixel value of the basic image is equal to or larger than the second threshold Th2 and less than the third threshold Th3. Accordingly, the low-bit basic image generating part 31-c determines the pixel value of the region PA3 as “2”. When the pixel position is in a region PA4, the pixel value of the basic image is equal to or larger than the first threshold Th1 and less than the second threshold Th2. Accordingly, the low-bit basic image generating part 31-c determines the pixel value of the region PA4 as “1”. When the pixel position is in a region PA5, the pixel value of the basic image is less than the first threshold Th1. Accordingly, the low-bit basic image generating part 31-c determines the pixel value of the region PA5 as “0”.

As described above, the image data before filtering are compared, at each of the pixels, to the threshold set based on the filtered image data in place of the filtered image data so that the image data DV-cb of the basic image can be generated. The number of bits to be allocated to the pixel has been determined as n bit(s) in the image data DV-cb according to the comparison result. The low-bit reference image generating part 31-r can also generate the image data DV-rb of the low-bit reference image by operating the same process as the low-bit basic image generating part 31-c.

### <4. Operation of Feature Value Calculating Part>

The feature value calculating part 41 calculates, at each of the blocks in the filtered low-bit basic image supplied from the low-bit basic image generating part 31-c, a feature value FD indicating the non-flatness of the brightness information. The feature value calculating part 41 calculates, for example, a dynamic range, a standard deviation, or a pseudo standard deviation as the feature value FD indicating the non-flatness of the brightness information.

When calculating a dynamic range DR as the feature value FD, the feature value calculating part 41 solves an expression (5). Note that Max (I′) denotes the maximum value of the filtered pixel data I′ in the block and Min (I′) denotes the minimum value of the filtered pixel data I′ in the block in the expression (5).

DR=(Max(I′)−Min(I′)) (5)

When calculating a standard deviation Std as the feature value FD, the feature value calculating part 41 solves an expression (6). Note that, in the expression (6), “ave (I′)” denotes an average value of the pixel data I′ in the block and “n” denotes the number of the pixels in the block.

$$Std = \sqrt{( {\sum }_{ij} {\vert {I}_{ij}^{′} - ave ( {I}^{′} ) )}^{2} ) / n} \qquad ( 6 )$$

When calculating a pseudo standard deviation PseudoStd as the feature value FD, the feature value calculating part 41 solves an expression (7). Note that “ave (I′)” denotes an average value of the pixel data I′ in the block in the expression (7). In the expression (7), it is not necessary to find the square or the root as shown in the expression (6) so that the expression (7) is more easily implemented than the expression (6).

$$PseudoStd = Ave ( {\sum }_{ij} \vert {I}_{ij} - ave ( {I}^{′} ) \vert ) \qquad ( 7 )$$

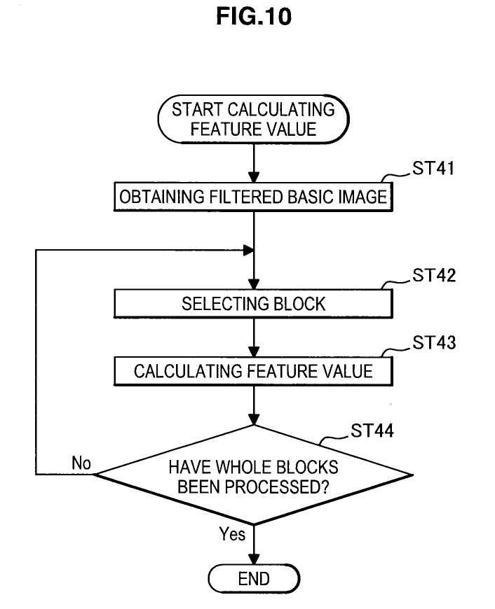

FIG. 10 is a flowchart of the operation of a feature value calculation. The feature value calculating part 41 obtains the filtered basic image in step ST41. The feature value calculating part 41 obtains the image data of the basic image filtered in the low-bit basic image generating part 31-c and the process goes to step ST42.

The feature value calculating part 41 selects a block in step ST42. The feature value calculating part 41 selects a block for calculating the feature value and the process goes to step ST43. Note that the block is set at a region in the basic image corresponding to the block for calculating the motion vector in the low-bit basic image.

The feature value calculating part 41 calculates the feature value in step ST43. The feature value calculating part 41 solves the expression (5), the expression (6), or the expression (7) to calculate the feature value and the process goes to step ST44.

The feature value calculating part 41 determines in step ST44 whether all the blocks have been calculated. The feature value calculating part 41 performs the process in step ST42 to select a new block among the blocks of which feature value has not been calculated and calculate the feature value when the block of which feature value has not been calculated remains. Alternatively, the feature value calculating part 41 terminates the process when the feature values of all the blocks have been calculated.

### <5. Operation of Cost Value Calculating Part>

The cost value calculating part 42 calculates, at each of the reference block positions, the cost value Cost between the current block in the low-bit basic image and the region to be examined in the low-bit reference image is calculated using the difference function and the feature value FD. The difference function indicates the difference between the examination position motion vector and the estimated motion vector. The feature value FD is relative to the current block.

When performing a block matching, the cost value calculating part 42 calculates the cost value at each of the reference block positions in the region to be examined using the difference function and the feature value. The difference function denotes the difference between the examination position motion vector and the estimated motion vector. The examination position motion vector denotes the motion between the current block in the basic image of which motion vector is to be calculated and the reference block in the region to be examined in the reference image. The feature value is relative to the current block to be calculated.

Two cases will be described below. One is where the motion vector at each of the blocks is calculated once. The other is where the motion vector at each of the blocks in the basic image is provisionally calculated in the same manner as the past based on the evaluation value obtained by a block matching and then is calculated again using the provisionally-calculated motion vector of each of the blocks. Note that the examination position motion vector MV is denoted as a motion vector (MVx, MVy) hereinafter.

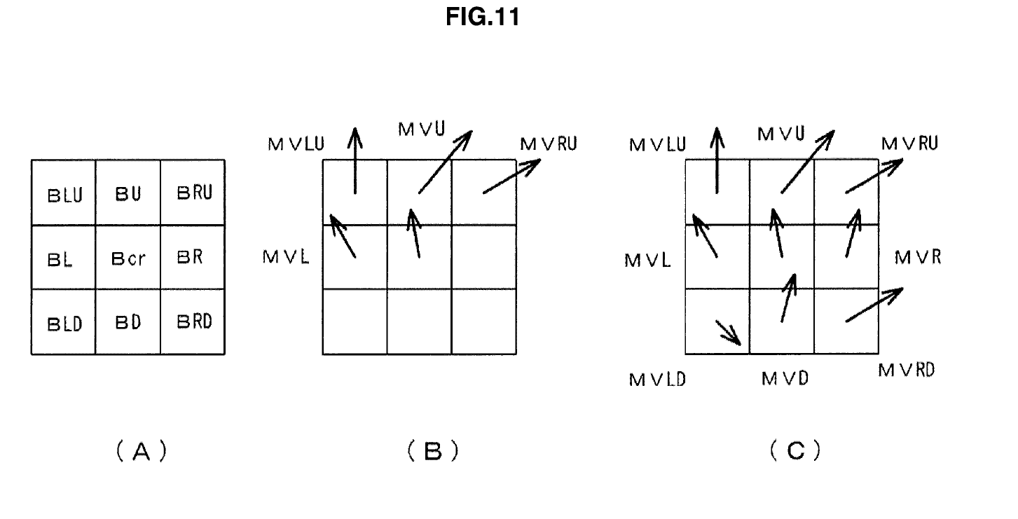

The cost value calculating part 42 uses, as the estimated motion vectors, for example, the calculated motion vectors of the blocks adjacent to the current block or the statistical result of the calculated motion vectors of the adjacent blocks. In view of the image of an object at rest, the cost value calculating part 42 includes a zero vector in the estimated motion vectors. FIG. 11 is an exemplary view of the calculated motion vectors of the adjacent blocks.

FIG. 11(A) is a view of a current block Bcr of which motion vector is to be calculated and the blocks adjacent to the current block in the basic image. For example, the adjacent block that is positioned at the upper left side of the current block is denoted as a block BLU. The adjacent block that is positioned at the upper side of the current block is denoted as a block BU. The adjacent block that is positioned at the upper right side of the current block is denoted as a block BRU. The adjacent block that is positioned at the left side of the current block is denoted as a block BL. The adjacent block that is positioned at the right side of the current block is denoted as a block BR. The adjacent block that is positioned at the lower left side of the current block is denoted as a block BLD. The adjacent block that is positioned at the lower side of the current block is denoted as a block BD. The adjacent block that is positioned at the lower right side of the current block is denoted as a block BRD.

When the motion vectors are calculated once, the motion vectors of the blocks are sequentially calculated, for example, in a horizontal order. When the motion vector of the current block is calculated, a motion vector MVLU of the upper left block BLU, a motion vector MVU of the upper block BU, a motion vector MVRU of the upper right block BRU, and a motion vector MVL of the left block BL have been calculated as shown in FIG. 11(B). Accordingly, the cost value calculating part 42 calculates the cost value using the calculated motion vector shown in FIG. 11(B).

When the motion vectors are calculated twice, a motion vector MVLU1 of the block BLU, a motion vector MVU1 of the block BU, a motion vector MVRU1 of the block BRU, a motion vector MVL1 of the block BL, a motion vector MVR1 of the block BR, a motion vector MVLD1 of the block BLD, a motion vector MVD1 of the block BD, and a motion vector MVRD1 of the block BRD are provisionally calculated at first as shown in FIG. 11(C). Accordingly, the cost value calculating part 42 calculates the cost value using each motion vector of the adjacent blocks shown in FIG. 11(C).

When the motion vectors are calculated once, the cost value calculating part 42 uses the zero vector and the provisionally-calculated motion vectors of the adjacent blocks as estimated motion vectors. The cost value calculating part 42 also uses, as the estimated motion vectors, the motion vector calculated by gathering the statistics of the provisionally-calculated motion vectors of the adjacent blocks. For example, the median of the motion vectors of the adjacent blocks that is denoted as a motion vector MVmed and the mean of the motion vectors of the adjacent blocks that is denoted as a motion vector MVmean are used as the estimated motion vectors.

The cost value calculating part 42 calculates the cost value Cost at each of the block positions using the difference function and the feature value calculated by the feature value calculating part 41. The difference function indicates the difference between the examination position motion vector and the estimated motion vector. The cost value calculating part 42 defines a difference function “Diff (MV1, MV2)” indicating the difference between the examination position motion vector and the estimated motion vector as an expression (8) and an expression (9). Note that the expression (8) corresponds to an L1 norm and the expression (9) corresponds to an L2 norm.

Diff(MV1, MV2)=|MV1x−MV2x|+|MV1y−MV2y| (8)

Diff(MV1, MV2)=\sqrt{(MV1x−MV2x)²+(MV1y−MV2y)²} (9)

The cost value calculating part 42 also sets an upper limit LMu on the difference as shown in an expression (10) to limit the influence of the function value of the difference function. For example, when a block matching between a one-bit basic image and a one-bit reference image is performed while the images are divided into blocks having the size of eight pixels by eight pixels, the maximum sum of absolute difference SAD becomes “64”. Thus, when the difference between the motion vectors is large, the ratio of the cost value Cost to the sum of absolute difference SAD becomes too high. Accordingly, setting the upper limit LMu on the difference prevents the ratio of the cost value Cost from being too high.

Func(MV1, MV2)=min(LMu, Diff(MV1, MV2)) (10)

The cost value calculating part 42 calculates the cost value Cost by solving an expression (11) using the function value by each estimated motion vector. Note that α, β1 to β4, γ1, and γ2 in the expression (11) denote adjustable parameters and denote “zero” or a positive number.

$$Cost = \frac{1}{FD} ( \begin{matrix}α ( Func ( MV , 0 ) ) + \\ {β}_{1} ( Func ( MV , {MV}_{LU} ) ) + {β}_{2} ( Func ( MV , {MV}_{U} ) ) + \\ {β}_{3} ( Func ( MV , {MV}_{RU} ) ) + {β}_{4} ( Func ( MV , {MV}_{L} ) ) + \\ {γ}_{1} ( Func ( MV , {MV}_{med} ) ) + {γ}_{2} ( Func ( MV , {MV}_{mean} ) )\end{matrix} ) \qquad ( 11 )$$

When the motion vectors are calculated twice, the cost value calculating part 42 uses the zero vector and the provisionally-calculated motion vectors of the adjacent blocks as estimated motion vectors. Note that, when the motion vectors are calculated twice, the motion vector of each block is provisionally calculated at first based on the evaluation value obtained by the block matching. The motion vector of each block has been provisionally calculated and then the motion vectors of the eight blocks adjacent to the current block are used as estimated motion vectors. The cost value calculating part 42 also uses, as the estimated vectors, the motion vector calculated by gathering the statistics of the calculated motion vectors of the adjacent blocks. For example, the median of the motion vectors of the adjacent blocks that is denoted as the motion vector MVmed and the mean of the motion vectors of the adjacent blocks that is denoted as the motion vector MVmean are used as the estimated motion vector.

The cost value calculating part 42 calculates the cost value Cost using the difference function and the feature value calculated by the feature value calculating part 41. The difference function indicates the difference between the examination position motion vector and the estimated motion vector. The cost value calculating part 42 defines a difference function “Diff (MV1, MV2)” indicating the difference between the examination position motion vector and the estimated motion vector as the expression (8) or the expression (9). The cost value calculating part 42 also limits the influence of the function value of the difference function by setting the upper limit LMu of the cost value as shown in the expression (10).

The cost value calculating part 42 solves an expression (12) using the function value by each estimated motion vector to calculate the cost value Cost at each of the reference block positions. Note that α, β1 to β8, γ1, and γ2 in the expression (12) denote adjustable parameters and denote “zero” or a positive number.

$$Cost = \frac{1}{FD} ( \begin{matrix}α ( Func ( MV , 0 ) ) + \\ {β}_{1} ( Func ( MV , {MV}_{LU} ) ) + {β}_{2} ( Func ( MV , {MV}_{U} ) ) + \\ {β}_{3} ( Func ( MV , {MV}_{RU} ) ) + {β}_{4} ( Func ( MV , {MV}_{L} ) ) + \\ {β}_{5} ( Func ( MV , {MV}_{R} ) ) + {β}_{6} ( Func ( MV , {MV}_{LD} ) ) + \\ {β}_{7} ( Func ( MV , {MV}_{D} ) ) + {β}_{8} ( Func ( MV , {MV}_{RD} ) ) + \\ {γ}_{1} ( Func ( MV , {MV}_{med} ) ) + {γ}_{2} ( Func ( MV , {MV}_{mean} ) )\end{matrix} ) \qquad ( 12 )$$

The cost value Cost that is calculated in this manner becomes small when the difference between the examination position motion vector and the estimated motion vector is small. When the non-flatness of the brightness information in the block is high, the cost value Cost becomes small. The motion vector of the adjacent block, for example, at the right or lower side can be also used as an estimated motion vector by provisionally calculating the motion vectors of each of the blocks in the basic image. Note that the number of the calculations for finding the cost value Cost can be reduced using a part of the estimated motion vectors shown in the expressions (11) and (12).

### <6. Configuration and Operation of Block Matching Part>

Next, the block matching part 43 will be described. Using the low-bit basic image and the low-bit reference image, the block matching part 43 calculates the evaluation value between the current block in the low-bit basic image and each of the reference block positions of the region to be examined in the reference image. The block matching part 43 also corrects the evaluation value at each of the reference block positions using the cost value calculated by the cost value calculating part 42 to calculate the motion vectors based on the corrected evaluation values. In other words, the block matching part 43 detects, based on the corrected evaluation values, the block position where the image of the block in the basic image is most similar to that in the reference image to calculate the motion vectors according to the coordinate value of the detected block position.

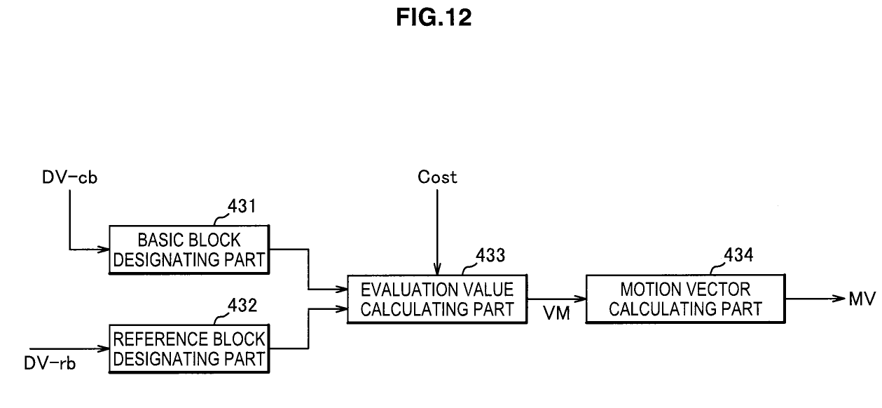

FIG. 12 is a view of the configuration of the block matching part 43. The block matching part 43 calculates the motion vector MV using the image data DV-cb on the low-bit basic image, the image data DV-rb on the low-bit reference image, and the cost value Cost.

A basic block designating part 431 designates a block in the low-bit basic image as the current block of which motion vector is to be calculated, and outputs the image data on the designated block to an evaluation value calculating part 433.

A reference block designating part 432 designates a region in the low-bit reference image as the region in which a motion vector is to be examined, and outputs the image data on the designated region to the evaluation value calculating part 433.

The evaluation value calculating part 433 calculates an evaluation value EVa between the current block designated by the basic block designating part 431 and the reference block in the region to be examined designated by the reference block designating part 432. The evaluation value EVa is sequentially calculated at each of the reference block positions in the region to be examined. The evaluation value calculating part 433 uses the evaluation value EVa that decreases as the similarity between the block of the low-bit basic image and that of the low-bit reference image becomes high. For example, the sum of absolute difference SAD or an XOR additional value SOX is used as the evaluation value EVa. A sum of squared difference (SSD), a normalized cross correlation (NCC), or the like can be also used as the evaluation value.

When using the sum of absolute difference SAD as the evaluation value EVa, the evaluation value calculating part 433 solves an expression (13). Note that, in the expression (13), T(i, j) denotes the pixel data on a position (i, j) in the block on the low-bit basic image, and S(i, j) denotes the pixel data on a position (i, j) in the block on the low-bit reference image.

$$SAD = {\sum }_{i} {\sum }_{j} \vert T ( i , j ) - S ( i , j ) \vert \qquad ( 13 )$$

When using the XOR additional value SOX as the evaluation value EVa, the evaluation value calculating part 433 solves expressions (14) and (15). Note that, in the expression (15) for finding an XOR value, T(i, j) denotes the pixel data on the position (i, j) in the block on the low-bit basic image, and S(i, j) denotes the pixel data on the position (i, j) in the block on the low-bit reference image.

$$\begin{matrix}SOX = {\sum }_{i} {\sum }_{j} XOR ( i , j ) & ( 14 ) \\ XOR = T ( i , j ) ⊗ S ( i , j ) & ( 15 )\end{matrix}$$

When the image data of the low-bit basic image and the low-bit reference image are n bit while the evaluation value calculating part 433 uses the XOR additional value SOX as the evaluation value EVa, an expression (16) is solved for finding the XOR value of the n bit. In other words, the expression (16) satisfies “XOR=0” when both image data are equal to each other, and the expression (16) satisfies “XOR=1” when both image data are different from each other. Note that, in the expression (16), “k” denotes the kth place of the number of bits to be allocated to the pixel.

$$XOR = T ( i , j ) ⊗ S ( i , j ) = {{⋃}_{k = 1}}^{n} ( {T}_{k} ( i , j ) ⊗ {S}_{k} ( i , j ) ) \qquad ( 16 )$$

The evaluation value calculating part 433 also corrects the evaluation value EVa by adding the cost value Cost to the calculated sum of absolute difference SAD or XOR additional value SOX, for example, as shown in an expression (17), to calculate a corrected evaluation value EVc and output the corrected evaluation value EVc to a motion vector calculating part 434.

EVc=EVa(SAD, SOX, or the like)+Cost (17)

The motion vector calculating part 434 detects, based on the corrected evaluation value EVc, the block position in the reference image most similar to the block of the basic image, namely, the block position having the smallest evaluation value EVc in the reference image. The motion vector MV is also calculated according to the difference between the coordinate of the block in the basic image and the coordinate of the block in the reference image most similar to the block in the basic image.

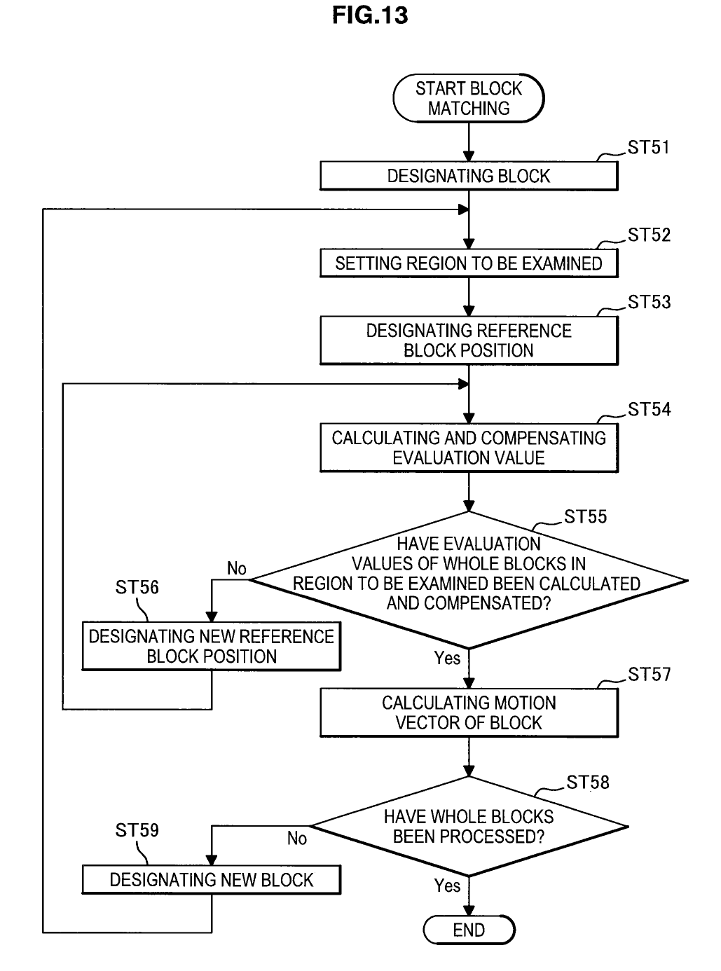

FIG. 13 is a flowchart of the operation of the block matching part 43. The block matching part 43 designates a block in the low-bit basic image in step ST51. The block matching part 43 designates the block as the current block of which motion vector is to be calculated in the low-bit basic image and then the process goes to step ST52.

The block matching part 43 sets a region to be examined in step ST52. The block matching part 43 sets a region to be examined in the low-bit reference image and then the process goes to step ST53.

The block matching part 43 designates a block position as the reference block position in step ST53. The block matching part 43 designates the reference block position in the region to be examined for detecting the motion vector and then the process goes to step ST54.

The block matching part 43 calculates and corrects the evaluation value in step ST54. The block matching part 43 calculates the evaluation value EVa according to the pixel data of the current block and the reference block. The block matching part 43 calculates the sum of absolute difference SAD, the XOR additional value SOX or the like as the evaluation value EVa. The block matching part 43 further calculates the corrected evaluation value EVc by adding the cost value to the calculated sum of absolute difference SAD or XOR additional value SOX.

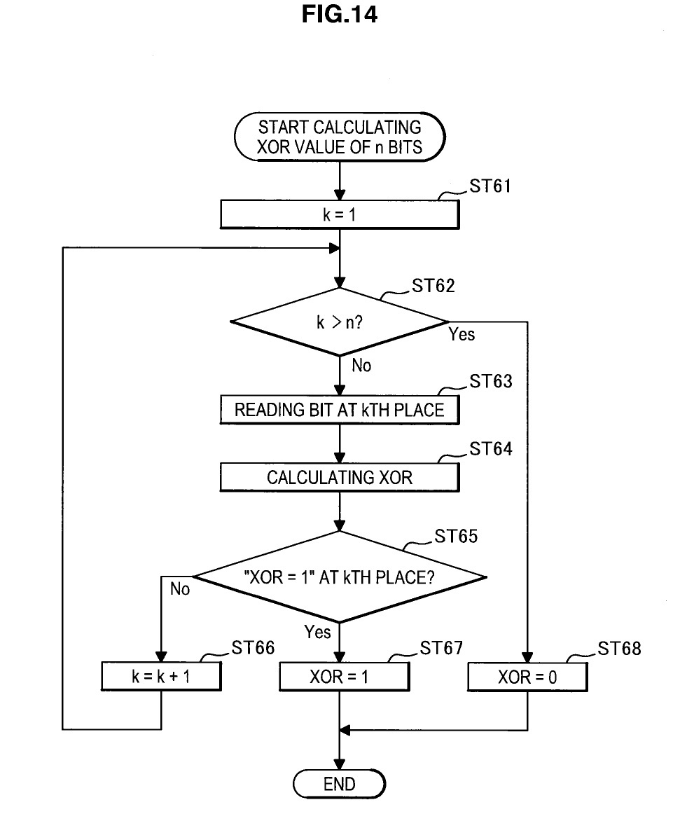

Note that, when the low-bit basic image and the low-bit reference image are n bit, the XOR value of each pixel in the block can be calculated by the process of the XOR value calculation shown in FIG. 14.

The block matching part 43 assumes a parameter k indicating a bit position as “k=1” in step ST61. The block matching part 43 sets the parameter k indicating a bit position as a value “k=1” indicating the least significant bit of the pixel data on the low-bit basic image and on the low-bit reference image and then the process goes to step ST62.

The block matching part 43 determines in step ST62 whether the parameter k has become larger than n. The block matching part 43 performs the process in step ST63 when the parameter k is not larger than the number of the most significant bit of the pixel data on the low-bit basic image and on the low-bit reference image. Alternatively, the block matching part 43 performs the process in step ST68 when the parameter k becomes larger than the number of the most significant bit of the pixel data on the low-bit basic image and on the low-bit reference image.

The block matching part 43 reads the kth place of the bits in step ST63. The block matching part 43 reads the data on the kth place of the bits from the pixel data on the low-bit basic image and on the low-bit reference image and then the process goes to step ST64.

The block matching part 43 performs the XOR calculation in step ST64. The block matching part 43 calculates the exclusive logical add of the data on the kth place of the bits that has been read in step ST63 and then the process goes to step ST65.

The block matching part 43 determines in step ST65 whether the XOR value of the kth place satisfies “XOR=1”. The block matching part 43 performs the process in step ST66 when the exclusive logical add of the kth place of the bits that has been calculated in step ST64 is equal to “0”. Alternatively, the block matching part 43 performs the process in step ST67 when the exclusive logical add of the kth place of the bits that has been calculated in step ST64 is equal to “1”.

The block matching part 43 performs the calculation “k=k+1” to update the parameter k in step ST66 and then the process goes back to step ST62.

The block matching part 43 assumes the XOR value of the n bit as “XOR=1” in step ST67 and the process is terminated.

The block matching part 43 assumes the XOR value of the n bit as “XOR=0” in step ST68 and the process is terminated.

In such a process, it is determined, in the order from the least significant bit to the most significant bit, whether the value of each bit in the pixel data on the low-bit basic image is equal to that on the low-bit reference image. When the values of the bits are not equal to each other, the XOR value is assumed as “XOR=1”. Alternatively, when the values of the whole bits are equal to each other, the XOR value is assumed as “XOR=0”. In other words, when the pixel data of the n bits on the low-bit basic image and on the low-bit reference image are not equal to each other, the XOR value of the n bits is assumed as “XOR=1”. When the pixel data of the n bits on the low-bit basic image and on the low-bit reference image are equal to each other, the XOR value of the n bits is assumed as “XOR=0”.

As described above, the XOR value when the image data on the low-bit basic image and on the low-bit reference image are n bit can be calculated.

FIG. 13 will be described again. The block matching part 43 determines in step ST55 whether the evaluation values have been calculated and corrected at the whole blocks in the region to be examined. The block matching part 43 performs the process in step ST56 when the calculation and revision of the evaluation value at each reference block position in the region to be examined has not been completed. The block matching part 43 performs the process in step ST57 when the calculation and revision of the evaluation value at each reference block position in the region to be examined has been completed.

The block matching part 43 freshly designates a position as a reference block in step ST56. The block matching part 43 freshly designates a position as a reference block in the region to be examined and then the process goes back to step ST54. The position is a reference block of which evaluation value has not been calculated and corrected.

The block matching part 43 detects a motion block corresponding to the basic block in step ST57. The block matching part 43 determines the reference block position most similar to the block in the basic image according to the calculated evaluation value EVc. A local motion vector is calculated according to the difference between the coordinate of the determined reference block position and the coordinate of the current block position in the basic image, and then the process goes to step ST58.

The block matching part 43 determines in step ST58 whether the whole blocks in the low-bit basic image have been processed. The block matching part 43 performs the process in step ST59 when an unprocessed block remains. Alternatively, the block matching part 43 terminates the block matching process when the whole blocks in the low-bit basic image have been processed.

The block matching part 43 freshly designates a block in step ST59. The block matching part 43 freshly designates a block of which motion vector has not been calculated and then the process goes back to step ST52

As described above, the present disclosure calculates the cost value Cost based on the difference between the examination position motion vector and the estimated motion vector, and corrects the evaluation value EVa for the block matching using the cost value Cost. The present disclosure also calculates the motion vector based on the block position having the minimum corrected evaluation value EVc. Accordingly, the motion vector similar to those of the adjacent blocks can be easily calculated. This can cause the dispersion of the motion vectors fewer than that in the case where the motion vectors are calculated without the cost value.

When the non-flatness of the brightness information of the block in the basic image is high or, in other word, when the feature value FD is large, the cost value Cost becomes small. On the other hand, when the non-flatness of the brightness information of the block in the basic image is low or, in other word, when the feature value FD is small, the cost value Cost becomes large. Thus, when the block in the basic image is flat, the cost value Cost becomes large and significantly contributes to the evaluation value EVa. Accordingly, when it is difficult to calculate an accurate motion vector because the variation of the evaluation value EVa in the region to be examined is small due to the flat block in the basic image, the motion vector is calculated using the motion vectors of the adjacent blocks. This can reduce the dispersion of the motion vectors. On the other hand, when the block in the basic image is complex, the cost value Cost becomes small and slightly contributes to the evaluation value EVa. Accordingly, when a motion vector is accurately calculated because the variation of the evaluation value EVa in the region to be examined is large due to the complex block in the basic image, the motion vector can be calculated based on the result of the block matching. Thus, the motion vector can be calculated more accurately than the motion vector that is calculated without the cost value and the dispersion of the motion vector is fewer than that of the motion vector that is calculated without the cost value.

The block matching part can be simply configured to calculate a motion vector because a low-bit image is used.

### <7. Process Performed by Program>

The above-described sequence of processes can be implemented by hardware and also by software. When software implements the processes, a computer is used, where a program constituting the software is installed on dedicated hardware. Alternatively, a program is installed from a record medium using, for example, a general personal computer capable of implementing each function by installing each program.

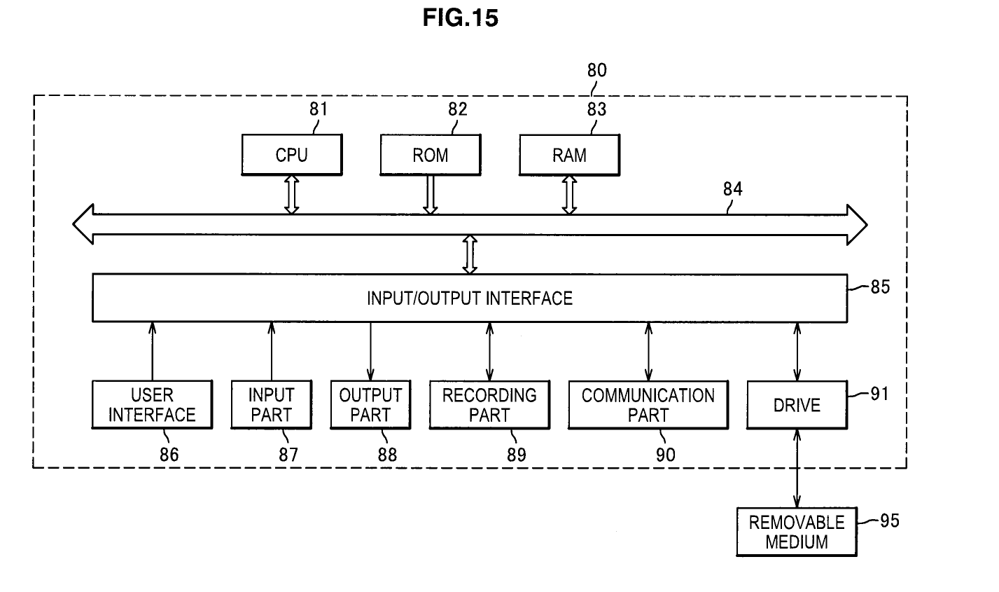

FIG. 15 is a view of an exemplary configuration of hardware on a computer where a program performs the above-described series of processes.

In a computer 80, a central processing unit (CPU) 81, a read only memory (ROM) 82, and a random access memory (RAM) 83 are interconnected to each other through a bus 84.

The bus 84 is also connected to an input/output interface 85. The input/output interface 85 is connected to a user interface 86 including a keyboard, a mouse and the like, an input part 87 for inputting the image data, an output part 88 including a display and the like, and a recording part 89 including a hard disc, a nonvolatile memory and the like. The input/output interface 85 is also connected to a communication part 90 including a network interface and the like, a drive 91 for driving a removable medium 95 such as a magnetic disk, an optical disk, a magneto optical disk, or a semiconductor memory.

In the computer including the above, the CPU 81 loads, for example, a program recorded in the recording part 89 into the RAM 83 through the input/output interface 85 and the bus 84, and executes the program so that the above-described sequence of processes is implemented.

The program executed by the computer (CPU 81) can be provided after recorded on the removable medium 95 as a package medium including, for example, a magnetic disk (including a flexible disk), an optical disk (compact disc-read only memory (CD-ROM), digital versatile disc (DVD) or the like), a magneto optical disk, or a semiconductor memory. Alternatively, the program can be provided through a wired or wireless transmission medium such as a local area network, the Internet, and a digital satellite broadcast.

The removable medium 95 is mounted on the drive 91 as a recording medium in which the program has been recorded so that the program can be installed on the recording part 89 through the input/output interface 85. Alternatively, the program can be installed on the recording part 89 after received by the communication part 90 through a wired or wireless transmission medium. Otherwise, the program can be installed on the ROM 82 or the recording part 89 in advance.

It should be understood by those skilled in the art that various modifications, combinations, sub-combinations and alterations may occur depending on design requirements and other factors insofar as they are within the scope of the appended claims or the equivalents thereof.

The information processing apparatus according to the present disclosure can be also configured as the following.

(1) The information processing apparatus including:

a low-bit basic image generating part for generating a low-bit basic image having a low bit depth from a basic image;

a low-bit reference image generating part for generating a low-bit reference image having a low bit depth from a reference image;

a feature value calculating part for calculating a feature value indicating a non-flatness of brightness information of the basic image;

a cost value calculating part for calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and

a block matching part for calculating a motion vector at each of the reference block positions based on an evaluation value after correcting the evaluation value using the calculated cost value, the evaluation value being obtained by the block matching between the low-bit basic image and the low-bit reference image.

(2) The information processing apparatus according to (1), wherein the cost value calculating part uses, as the estimated motion vector, motion vectors of blocks adjacent to the block in the low-bit basic image on which to perform the block matching.

(3) The information processing apparatus according to (2),

wherein the block matching part provisionally calculates the motion vector at each of the blocks in the low-bit basic image based on the evaluation value obtained by the block matching,

the cost value calculating part uses, as the estimated motion vector, the provisionally-calculated motion vectors of the adjacent blocks.

(4) The information processing apparatus according to (2) or (3), wherein the cost value calculating part uses, as the estimated motion vector, a motion vector calculated by gathering statistics the provisionally-calculated motion vectors of the adjacent blocks.

(5) The information processing apparatus according to any one of (1) to (4), wherein the cost value calculating part uses a zero vector as the estimated motion vector.

(6) The information processing apparatus according to any one of (1) to (5), wherein the cost value calculating part calculates the cost value using a difference function indicating the difference between the estimated motion vector and a motion vector between the block of the low-bit basic image and the reference block.

(7) The information processing apparatus according to (6), wherein the cost value calculating part limits an upper limit of the difference to a predetermined value.

(8) The information processing apparatus according to any one of (1) to (7), wherein the feature value calculating part calculates, as the feature value, a dynamic range or a deviation of the brightness information of a region in the basic image corresponding to the block in the low-bit basic image.

(9) The information processing apparatus according to any one of (1) to (8), wherein the feature value calculating part calculates the feature value using a basic image that has been filtered.

In the information processing apparatus, the information processing method, the program, and the recording medium according to the present disclosure, the feature value indicating the non-flatness of the brightness information is calculated at each predetermined block in the basic image. The cost value at each of the block positions is calculated using the feature value and the estimated motion vectors when the block matching between the low-bit basic image and the low-bit reference image is performed. An evaluation value is obtained by the block matching between the low-bit basic image and the low-bit reference image, and is corrected using the cost value calculated at each block position. Then the motion vector is calculated based on the corrected evaluation value. Accordingly, the motion vector is accurately calculated by a simple configuration. This is suitably applied to an electronic appliance having a function for encoding an image, for example, an imaging device, an image recording device, or an image editing device.

The present disclosure contains subject matter related to that disclosed in Japanese Priority Patent Application JP 2011-137681 filed in the Japan Patent Office on Jun. 21, 2011, the entire content of which is hereby incorporated by reference.

What is claimed is:

1. An information processing apparatus comprising:
a low-bit basic image generating part for generating a low-bit basic image having a low bit depth from a basic image;
a low-bit reference image generating part for generating a low-bit reference image having a low bit depth from a reference image;
a feature value calculating part for calculating a feature value indicating a non-flatness of brightness information of the basic image;
a cost value calculating part for calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and
a block matching part for calculating a motion vector at each of the reference block positions based on an evaluation value after correcting the evaluation value using the calculated cost value, the evaluation value being obtained by the block matching between the low-bit basic image and the low-bit reference image.

2. The information processing apparatus according to claim 1, wherein the cost value calculating part uses, as the estimated motion vector, motion vectors of blocks adjacent to the block in the low-bit basic image on which to perform the block matching.

3. The information processing apparatus according to claim 2,
wherein the block matching part provisionally calculates the motion vector at each of the blocks in the low-bit basic image based on the evaluation value obtained by the block matching, and
the cost value calculating part uses, as the estimated motion vector, the provisionally-calculated motion vectors of the adjacent blocks.

4. The information processing apparatus according to claim 2, wherein the cost value calculating part uses, as the estimated motion vector, a motion vector calculated by gathering statistics using the provisionally-calculated motion vectors of the adjacent blocks.

5. The information processing apparatus according to claim 2, wherein the cost value calculating part uses a zero vector as the estimated motion vector.

6. The information processing apparatus according to claim 2, wherein the cost value calculating part calculates the cost value using a difference function indicating the difference between the estimated motion vector and a motion vector between the block of the low-bit basic image and the reference block.

7. The information processing apparatus according to claim 6, wherein the cost value calculating part limits an upper limit of the difference to a predetermined value.

8. The information processing apparatus according to claim 1, wherein the feature value calculating part calculates, as the feature value, a dynamic range or a deviation of the brightness information of a region in the basic image corresponding to the block in the low-bit basic image.

9. The information processing apparatus according to claim 1, wherein the feature value calculating part calculates the feature value using a basic image that has been filtered.

10. An information processing method comprising:
generating a low-bit basic image having a low bit depth from a basic image;
generating a low-bit reference image having a low bit depth from a reference image;
calculating a feature value indicating a non-flatness of brightness information of the basic image;
calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and
calculating a motion vector at each of the reference block positions based on an evaluation value after correcting the evaluation value using the calculated cost value, the evaluation value being obtained by the block matching between the low-bit basic image and the low-bit reference image.

11. A program for causing a computer to calculate a motion vector, the program causing the computer to execute:
generating a low-bit basic image having a low bit depth from a basic image;
generating a low-bit reference image having a low bit depth from a reference image;
calculating a feature value indicating a non-flatness of brightness information of the basic image;
calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and
calculating a motion vector at each of the reference block positions based on an evaluation value after correcting the evaluation value using the calculated cost value, the evaluation value being obtained by the block matching between the low-bit basic image and the low-bit reference image.

12. A computer-readable recording medium storing a program for causing a computer to calculate a motion vector, the program causing the computer to execute:
generating a low-bit basic image having a low bit depth from a basic image;
generating a low-bit reference image having a low bit depth from a reference image;
calculating a feature value indicating a non-flatness of brightness information of the basic image;
calculating a cost value at each of reference block positions in a block matching between the low-bit basic image and the low-bit reference image using the feature value of a block in the basic image corresponding to a block in the low-bit basic image and an estimated motion vector set at the block in the low-bit basic image; and
calculating a motion vector at each of the reference block positions based on an evaluation value after correcting the evaluation value using the calculated cost value, the evaluation value being obtained by the block matching between the low-bit basic image and the low-bit reference image.
